(19) United States
(12) Patent Application Publication
(10) Pub. No.: US 2022/0126370 A1
(43) Pub. Date: Apr. 28, 2022

(54) Method and Apparatus for Fabrication of All-in-one Radiation Shielding Components with Additive Manufacturing

(71) Applicants: Jian Liu, Cary, NC (US); Shuang Bai, Cary, NC (US)

(72) Inventors: Jian Liu, Cary, NC (US); Shuang Bai, Cary, NC (US)

(73) Assignee: PolarOnyx, Inc., Chapel Hill, NC (US)

(21) Appl. No.: 17/511,073

(22) Filed: Oct. 26, 2021

Related U.S. Application Data
(60) Provisional application No. 63/106,309, filed on Oct. 27, 2020.
(60) Provisional application No. 63/110,901, filed on Nov. 6, 2020.

(51) Int. Cl. B22F 10/36; B22F 12/49; B22F 12/58; B22F 10/85; B22F 1/065; B22F 1/062; B22F 1/068; B33Y 10/00; B33Y 30/00; B33Y 70/10

(52) U.S. Cl. CPC B22F 10/36; B22F 12/49; B22F 12/58; B22F 10/85; B22F 1/065; B22F 12/30; B22F 1/068; B33Y 10/00; B33Y 30/00; B33Y 70/10; B22F 1/062

(57) ABSTRACT

Methods and apparatuses for AM of all-in-one radiation shielding components from multi-material metal alloys, metal matrix, MMCs, and/or gradated compositions of the same are disclosed, comprising: providing an apparatus having: an energy source; a scanner; a powder system for powder(s); a powder delivery system; a shielding gas; and a computer coupled to and configured to control the energy source, scanner, powder system, and powder delivery system to deposit layers of the sample; programming the computer with specifications of the sample; using the computer to control electromagnetic radiation, mixing ratio, and powder deposition parameters based on the specifications of the sample; and using the autofocusing scanner to focus and scan the electromagnetic radiation onto the sample while the powders are concurrently deposited by the powder delivery system onto the sample to create a melting pool to deposit one or more layers onto the sample. Other embodiments are described and claimed.

### CROSS REFERENCE TO RELATED ANNLICNTINNS

This application claims the benefit of the filing date of U.S. Provisional Patent Application Ser. No. 63/106,309, filed on Oct. 27, 2020, entitled “Method and Apparatus for Fabrication of Corrosion and Crack Resistant SiC Metal Matrix Composites with Additive Manufacturing” and U.S. Provisional Patent Application Ser. No. 63/110,901, filed on Nov. 6, 2020, entitled “Method and Apparatus for Fabrication of All-in-one Radiation Shielding Components with Additive Manufacturing.” All of the foregoing applications are hereby incorporated by reference herein in their entirety.

### STATEMENT REGARDING FEDERALLY SPONSORED RESEARCH

The U.S. Government has a paid-up license in this invention and the right in limited circumstances to require the patent owner to license others on reasonable terms as provided for by the terms of the NAVY SBIR contracts N68335-20-C-0559 and N68335- 20-C-0734, NASA SBIR contracts 80NSSC20C0593 and 80NSSC21C0471, DOE SBIR contract DE-SC0019721, and NIH SBIR contract 1R43GM137629-01.

### BACKGROUND

The invention relates generally to the field of three-dimensional additive manufacturing (AM) systems and fabrication of light weight radiation enclosures or components (such as collimators). More particularly, the invention relates to a method and apparatus for all-in-one multi-material fabrication including at least two of these materials: Aluminum (Al), Tungsten (W), Boron Carbide (BC), Boron (B), and/or Silicon Carbide (SiC) to form either metal alloys or metal matrix, and/or metal matrix composites (MMC) with crack and corrosion resistant properties to shield x-ray, gamma, and neutron radiation all-in-one.

### SUMMARY

In one respect, disclosed is a method for AM of all-in-one radiation shielding components from multi-material metal alloys, metal matrix, metal matrix composites, and/or gradated compositions of the same from two or more powders in additive manufacturing comprising: (a) providing an apparatus having: an electromagnetic energy source configured to generate electromagnetic radiation; an autofocusing scanner configured to receive the electromagnetic radiation from the electromagnetic energy source and to focus and scan the electromagnetic radiation onto a stage where a sample is additively manufactured; a powder system comprising N powder vessels for the two or more powders, wherein at least one of the two or more powders comprises Al, W, B, BC, and/or SiC; a powder delivery system configured to receive the two or more powders from the powder system and to deposit the two or more powders onto the stage in the vicinity of the focused and scanned electromagnetic radiation; a shielding gas either within a process chamber or as a flowing gas, wherein the shielding gas comprises argon and/or nitrogen; and one or more computers coupled to the electromagnetic energy source, the autofocusing scanner, the powder system, and the powder delivery system and configured to control the electromagnetic energy source, the autofocusing scanner, the powder system, and the powder delivery system to deposit one or more layers of the sample for metal alloys, metal matrix, metal matrix composite synthesis, and/or gradated composition of the same, wherein the one or more layers comprise at least one new material which differs from the two or more powders; (b) programming the one or more computers with structural and material specifications of the sample to be additively manufactured; (c) using the one or more computers to control electromagnetic radiation parameters; (d) using the one or more computers to control mixing ratio parameters between the two or more powders; (e) using the one or more computers to control powder deposition parameters based on the structural and material specifications of the sample programmed into the one or more computers; and (f) using the autofocusing scanner to focus and scan the electromagnetic radiation onto the sample while the two or more powders are concurrently deposited by the powder delivery system onto the sample in order to create a melting pool to deposit one or more layers onto the sample, wherein the one or more layers comprises metal alloys, metal matrix composites, and/or gradated composition. MMC comprises at least one of Al, W, B and at least one of SiC and BC. Metal alloys include at least two of these elements: Al, W, B.

In another respect, disclosed is an apparatus for AM of all-in-one radiation shielding components from metal alloys, metal matrix, metal matrix composites, and/or gradated compositions of the same from two or more powders in additive manufacturing comprising: an electromagnetic energy source configured to generate electromagnetic radiation; an autofocusing scanner configured to receive the electromagnetic radiation from the electromagnetic energy source and to focus and scan the electromagnetic radiation onto a stage where a sample is additively manufactured; a powder system comprising N powder vessels for the two or more powders, wherein at least one of the two or more powders comprises Al, W, B, BC, and/or SiC; a powder delivery system configured to receive the two or more powders from the powder system and to deposit the two or more powders onto the stage in the vicinity of the focused and scanned electromagnetic radiation; a shielding gas either within a process chamber or as a flowing gas, wherein the shielding gas comprises argon and/or nitrogen; and one or more computers coupled to the electromagnetic energy source, the autofocusing scanner, the powder system, and the powder delivery system and configured to control the electromagnetic energy source, the autofocusing scanner, the powder system, and the powder delivery system to deposit one or more layers of the sample for metal alloy, metal matrix composite synthesis, and/or gradated metal alloy or MMC, wherein the one or more layers comprise at least one new material which differs from the two or more powders.

Numerous additional embodiments are also possible.

### BRIEF DESCRIPTION OF THE DRAWINGS

Other objects and advantages of the invention may become apparent upon reading the detailed description and upon reference to the accompanying drawings.

FIG. 1 is a schematic illustration of several materials which may be used for radiation shielding or radiation components (such as collimators), in accordance with some embodiments.

FIG. 2 is a table of thicknesses needed to attenuate the radiation over 95% for materials of Al, B, W, Lead (Pb), Iron (Fe), Si, and SiC.

FIG. 3 is a schematic illustration of a mixed SiC and aluminum alloy during three-dimensional additive manufacturing, in accordance with some embodiments. SiC and Al composition percentage and particle size and shape are optimized for x-ray shielding with desired mechanical strength and crack resistance. To make more broad and high attenuation, mixed Al and W is a good combination and easier to make in AM, although pure W is the best, but hard to make in AM.

FIGS. 4A and 4B are schematic illustrations of a mixed W, B, Al MMC and a mixed W, BC, Al alloy matrix during three-dimensional additive manufacturing, respectively, in accordance with some embodiments. W, B, BC, and Al composition percentage and particle size and shape are optimized for simultaneous x-ray, gamma, and neutron shielding with desired attenuation, mechanical strength, and crack resistance.

FIG. 5 illustrates the mechanism for crack and corrosion resistance effects in MMC including SiC. SiC works as a blocker for crack and corrosion growth in MMC components. Moreover, the growth of SiO₂ (oxidation process: SiC+O₂→SiO₂+CO₂) on the surface of SiC particle (scattered in MMC) forms a layer of protection to prevent corrosion growth to further damage of the SiC matrix and to fill in the gap caused by cracks (self healing).

FIG. 6 illustrates the mechanism for crack and corrosion resistance effects in MMC including BC. Boron carbide works as a blocker to prevent corrosion growth to further damage of the BC matrix and to fill in the gap caused by cracks (self healing).

FIG. 7 is a graph which shows corrosion current tests for two SiC/Al MMCs with different compositions versus temperature.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Current tools and technologies do not provide for the fabrication of parts having a complex shape and sophisticated composition for the custom tailoring of the properties of the parts. Additive manufacturing or 3D printing technology is an enabling technology which does provide for the fabrication of complex shapes, but unfortunately, current additive manufacturing technologies require that the powders with a given composition must be alloyed and made with either plasma or gas atomization techniques prior to their use in the additive manufacturing process. Moreover additive manufacturing of ceramic such as SiC or BC usually involves binders for sintering at temperatures much lower than the melting point and the post heating and annealing.

Given these challenges, methods and apparatuses for additive manufacturing with in situ synthesis of SiC or BC MMCs which directly melt powders instead of binders are needed. The methods and apparatuses of the invention described herein may solve these shortcomings as well as others by proposing a novel method and apparatus for in situ synthesis of SiC or BC MMCs during three-dimensional additive manufacturing.

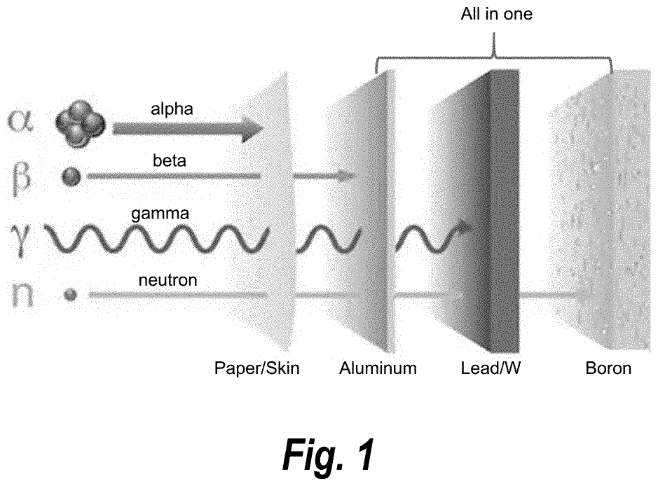

FIG. 1 is a schematic illustration of several materials which may be used for radiation shielding, in accordance with some embodiments. Paper and skin are effective in shielding alpha radiation, but not for beta, gamma, or neutron radiation. Aluminum is effective in shielding beta radiation, but not for gamma or neutron radiation. Lead and Tungsten are effective in shielding gamma radiation, but not neutron radiation. Boron is effective in shielding neutron radiation.

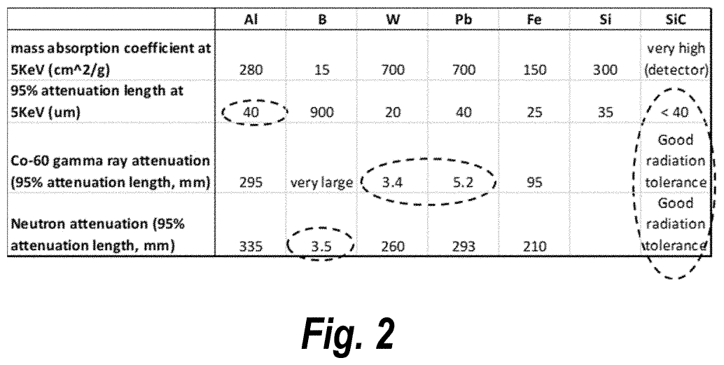

FIG. 2 is a table of thicknesses needed to attenuate the radiation over 95% for materials of Al, B, W, Pb, Fe, Si, and SiC. Aluminum shows an attenuation length of 40 μm for 95% attenuation at 5 keV. Tungsten and Lead show an attenuation length of 3.4 mm and 5.2 mm, respectively, for 95% attenuation of Co-60 gamma ray radiation. Boron shows an attenuation length of 3.5 mm for 95% attenuation of neutron radiation. Silicon carbide exhibits good radiation tolerance for beta, gamma, and neutron radiation.

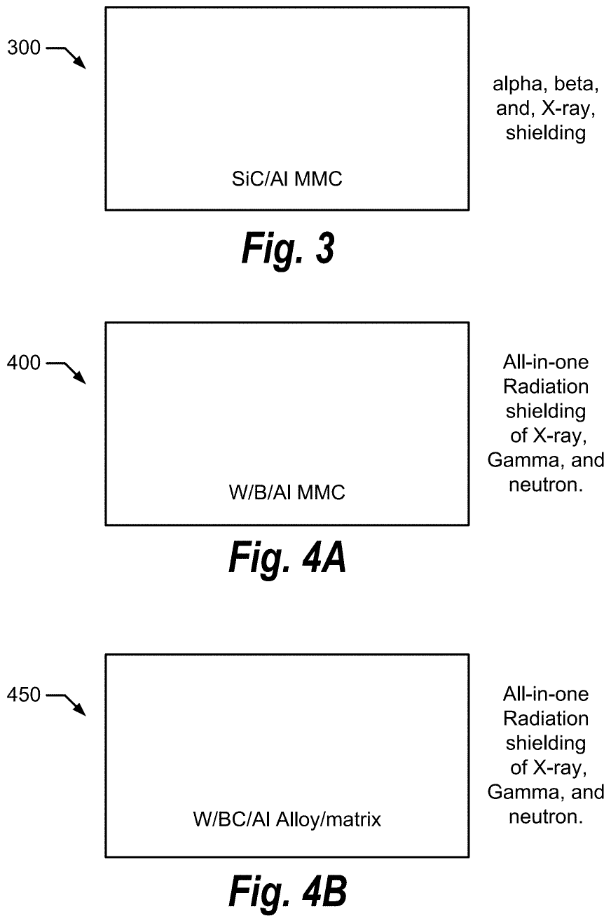

FIG. 3 is a schematic illustration of a mixed SiC and aluminum alloy 300 formed during three-dimensional additive manufacturing to shield x-ray<10 keV, in accordance with some embodiments. FIGS. 4A and 4B are schematic illustrations of a mixed W, B, Al MMC 400 and a mixed W, BC, Al alloy matrix 450 during three-dimensional additive manufacturing, respectively, to shield x-ray, gamma and neutron radiation simultaneously, in accordance with some embodiments.

In some embodiments, for SiC MMC and BC MMC synthesis, at least one metal powder (Al or W) and SiC or BC powder are mixed, either premixed or mixed real time in-situ, and then new phases, new compounds, and/or alloys are synthesized either partially or totally during melting of the additive manufacturing process. By control of the ratio from 1-100 of mixing percentages (in volume %, wt %, or mol %), energy deposition (creating melting pool temperatures around the melting point of SiC, i.e. temperatures ranging between about 1000° C. to about 3500° C.), powder shape (spherical, whisker, wire, fiber, flake each of which is loaded into their own powder vessel of the N-number of powder vessels), and powder size (nano particle) and distribution, it can form metal alloys (high percentage of metal) and metal matrix composites (high percentage of ceramics) with desired performance. It might also generate amorphous single element. Metals can be selected from aluminum or tungsten.

In an alternate embodiment, mixing both aluminum alloy and SiC powders with an appropriate ratio from 1-100 of SiC powder percentage to aluminum alloy powder percentage may generate the MMC sample of mixed SiC and Al alloy with an excellent strength, stiffness, light weight, and resistance to wear and environment (corrosion, erosion). New compounds may also be synthesized. For example: SiC+Al yields to Al₄C₃ and Si. This will tailor the mechanical properties such as strength, stiffness, hardness, Young's modulus, wear resistance, thermal conductivity, and/or thermal expansion coefficient (TEC), to fit to certain applications, such as engine, brakes, sports tools, machine tools, aerospace parts, etc.

In yet another alternate embodiment, W is mixed with BC with an appropriate ratio from 1-100 of BC powder percentage to W powder percentage to form an effective shielding component to handle high temperature and high radiation environment in nuclear energy. WB, WC, and W₂C may be synthesized during the process. Powder size (nano particle), shape (spherical, whisker, wire, fiber, flake, etc.) and distribution may be optimized for strength, stiffness, wear resistance, etc. This provides an excellent combination of high-temperature capability, relatively low neutron absorption, low radioactivity, high thermal conductivity, high mechanical strength, and excellent chemical stability. It can be used in high temperature environments such as nuclear reactors, plasma facing components, and nuclear propulsion rockets and vehicles.

FIG. 4A is a schematic illustration of mixed W, Al with B with an appropriate ratio from 1-100 of B powder percentage to W and Al powder percentage to form an effective x-ray, gamma, and neutron radiation shielding component to handle high temperature and high radiation environment in nuclear energy. Powder size (nano particle), shape (spherical, whisker, wire, fiber, flake, etc.) and distribution may be optimized for strength, stiffness, wear resistance, etc. This provides an excellent combination of high-temperature capability, relatively low neutron absorption, low radioactivity, high thermal conductivity, high mechanical strength, and excellent chemical stability. It can be used in high temperature environments such as nuclear reactors, plasma facing components, and nuclear propulsion rockets and vehicles.

FIG. 4B is a schematic illustration of mixed W, Al with BC with an appropriate ratio from 1-100 of BC powder percentage to W and Al powder percentage to form an effective x-ray, gamma, and neutron radiation shielding component to handle high temperature and high radiation environment in nuclear energy. WB, WC, AlC, and W₂C may be synthesized during the process. Powder size (nano particle), shape (spherical, whisker, wire, fiber, flake, etc.) and distribution may be optimized for strength, stiffness, wear resistance, etc. This provides an excellent combination of high-temperature capability, relatively low neutron absorption, low radioactivity, high thermal conductivity, high mechanical strength, and excellent chemical stability. It can be used in high temperature environments such as nuclear reactors, plasma facing components, and nuclear propulsion rockets and vehicles.

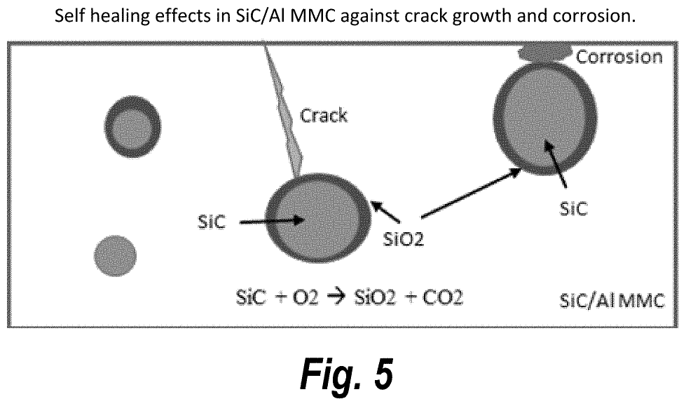

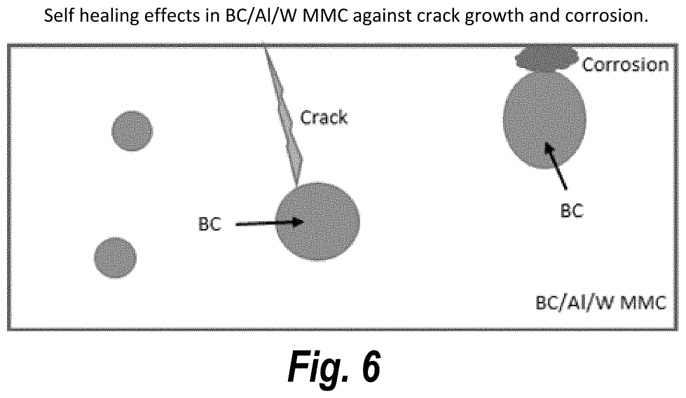

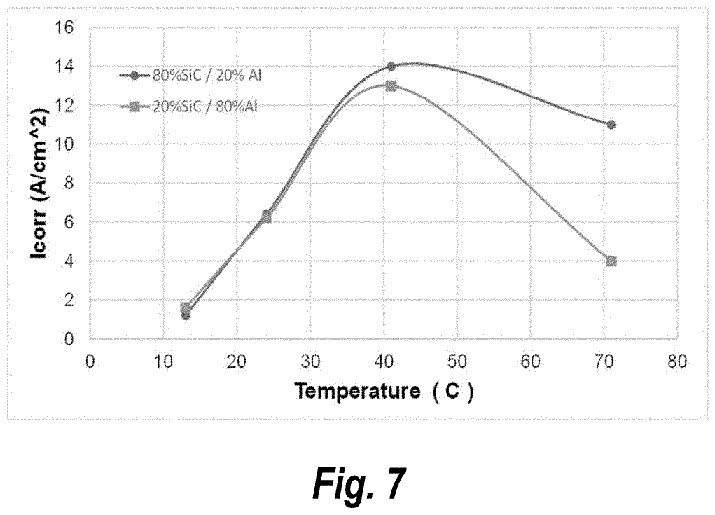

FIG. 5 and FIG. 6 illustrate the crack growth and corrosion resistance behaviors of SiC/Al MMC and BC/Al/W MMC, respectively. SiC and BC matrix plays critical roles in reinforcement of mechanical strength and blocking of cracks. Formation of SiO₂ on the surface of SiC due to oxidation process (SiC+O₂→SiO₂+CO₂) plays a role of self-healing to fill in the gaps formed by cracks and reducing the corrosion rate or even reversing the corrosion (as shown in FIG. 7). BC also works as a blocker for crack and corrosion growth in MMC components.

FIG. 7 shows corrosion current tests for two SiC/Al MMCs with different compositions under various temperatures. It shows that when the temperature goes up, the corrosion rate is reduced significantly instead of going up. This is an indication of self-healing effects, mainly caused by oxidation of SiC (SiC+O₂→SiO₂+CO₂).

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for AM of all-in-one radiation shielding components from multi-material metal alloys, metal matrix, metal matrix composites, and/or gradated compositions of the same from two or more powders in additive manufacturing comprising:
(a) providing an apparatus having:
an electromagnetic energy source configured to generate electromagnetic radiation;
an autofocusing scanner configured to receive the electromagnetic radiation from the electromagnetic energy source and to focus and scan the electromagnetic radiation onto a stage where a sample is additively manufactured;
a powder system comprising N powder vessels for the two or more powders, wherein at least one of the two or more powders comprises Al, W, B, BC, and/or SiC;
a powder delivery system configured to receive the two or more powders from the powder system and to deposit the two or more powders onto the stage in the vicinity of the focused and scanned electromagnetic radiation;
a shielding gas either within a process chamber or as a flowing gas, wherein the shielding gas comprises argon and/or nitrogen; and
one or more computers coupled to the electromagnetic energy source, the autofocusing scanner, the powder system, and the powder delivery system and configured to control the electromagnetic energy source, the autofocusing scanner, the powder system, and the powder delivery system to deposit one or more layers of the sample for the metal alloys, the metal matrix, the metal matrix composite, and/or the gradated composition of the same, wherein the one or more layers comprise at least one new material which differs from the two or more powders;
(b) programming the one or more computers with structural and material specifications of the sample to be additively manufactured;
(c) using the one or more computers to control electromagnetic radiation parameters;
(d) using the one or more computers to control mixing ratio parameters between the two or more powders;
(e) using the one or more computers to control powder deposition parameters based on the structural and material specifications of the sample programmed into the one or more computers; and
(f) using the autofocusing scanner to focus and scan the electromagnetic radiation onto the sample while the two or more powders are concurrently deposited by the powder delivery system onto the sample in order to create a melting pool to deposit one or more layers onto the sample,
wherein the one or more layers comprises the metal alloys, the metal matrix composites, and/or the gradated composition of the same;
wherein the metal alloys comprises at least two of: Al, W, and B; and
wherein the metal matrix composites comprises at least one of: Al, W, and B and at least one of SiC and BC.

2. The method of claim 1, wherein the SiC comprises at least one of a spherical shaped SiC powder, a whisker shaped SiC powder, a wire shaped SiC powder, a fiber shaped SiC powder, and a flake shaped SiC powder.

3. The method of claim 1, wherein the BC comprises a spherical shaped BC powder, a whisker shaped BC powder, a wire shaped BC powder, a fiber shaped BC powder, and/or a flake shaped BC powder.

4. The method of claim 1, further comprising forming the sample into shielding components, wherein the shielding components are configured to substantially block beta, x-ray, gamma, and neutron radiation.

5. The method of claim 4, further comprising optimizing powder percentage ratios of each of the two or more powders from 1-100 so that the shielding components substantially block x-ray, gamma, and neutron radiation.

6. The method of claim 1, wherein the B comprises a spherical shaped B powder, a whisker shaped B powder, a wire shaped B powder, a fiber shaped B powder, and/or a flake shaped B powder.

7. The method of claim 1, wherein the melting pool has a temperature ranging from about 1000° C. to about 3500° C.

8. The method of claim 1, wherein addition of SiC and/or BC results in the sample having a reinforced mechanical strength and a blocker to crack and corrosion growth.

9. The method of claim 7, wherein the sample is self-healing.

10. An apparatus for AM of all-in-one radiation shielding components from multi-material metal alloys, metal matrix, metal matrix composites, and/or gradated compositions of the same from two or more powders in additive manufacturing comprising:
an electromagnetic energy source configured to generate electromagnetic radiation;
an autofocusing scanner configured to receive the electromagnetic radiation from the electromagnetic energy source and to focus and scan the electromagnetic radiation onto a stage where a sample is additively manufactured;
a powder system comprising N powder vessels for the two or more powders wherein at least one of the two or more powders comprises Al, W, B, BC, and/or SiC;
a powder delivery system configured to receive the two or more powders from the powder system and to deposit the two or more powders onto the stage in the vicinity of the focused and scanned electromagnetic radiation;
a shielding gas either within a process chamber or as a flowing gas, wherein the shielding gas comprises argon and/or nitrogen; and
one or more computers coupled to the electromagnetic energy source, the autofocusing scanner, the powder system, and the powder delivery system and configured to control the electromagnetic energy source, the autofocusing scanner, the powder system, and the powder delivery system to deposit one or more layers of the sample for the metal alloys, the metal matrix, the metal matrix composite, and/or the gradated composition of the same,
wherein the one or more layers comprise at least one new material which differs from the two or more powders;
wherein the one or more layers comprises the metal alloys, the metal matrix composites, and/or the gradated composition of the same;
wherein the metal alloys comprises at least two of: Al, W, and B; and
wherein the metal matrix composites comprises at least one of: Al, W, and B and at least one of SiC and BC.

11. The apparatus of claim 10, wherein the SiC comprises at least one of a spherical shaped SiC powder, a whisker shaped SiC powder, a wire shaped SiC powder, a fiber shaped SiC powder, and a flake shaped SiC powder.

12. The apparatus of claim 10, wherein the BC comprises a spherical shaped BC powder, a whisker shaped BC powder, a wire shaped BC powder, a fiber shaped BC powder, and/or a flake shaped BC powder.

13. The apparatus of claim 10, wherein the B comprises a spherical shaped B powder, a whisker shaped B powder, a wire shaped B powder, a fiber shaped B powder, and/or a flake shaped B powder.

14. The apparatus of claim 10, wherein the melting pool has a temperature ranging from about 1000° C. to about 3500° C.

15. The apparatus of claim 10, wherein the sample comprises shielding components configured to substantially block beta, x-ray, gamma, and neutron radiation.

16. The apparatus of claim 15, wherein powder percentage ratios of each of the two or more powders are optimizes from 1-100 so that the shielding components substantially block x-ray, gamma, and neutron radiation.

17. The apparatus of claim 10, wherein addition of SiC and/or BC results in the sample having a reinforced mechanical strength and a blocker to crack and corrosion growth.

18. The apparatus of claim 14, wherein the sample is self-healing.
